(19) United States
(12) Patent Application Publication
(10) Pub. No.: US 2014/0219374 A1
(43) Pub. Date: Aug. 7, 2014

(54) EFFICIENT MULTIPLY-ACCUMULATE PROCESSOR FOR SOFTWARE DEFINED RADIO

(71) Applicant: Samsung Electronics Co., LTD, Suwon-si (KR)

(72) Inventor: Eran Pisek, Plano, TX (US)

(73) Assignee: Samsung Electronics Co., LTD, Suwon-si (KR)

(21) Appl. No.: 14/033,283

(22) Filed: Sep. 20, 2013

Related U.S. Application Data
(60) Provisional application No. 61/759,891, filed on Feb. 1, 2013.
(60) Provisional application No. 61/847,326, filed on Jul. 17, 2013.

(51) Int. Cl. H04L 27/26

(52) U.S. Cl. CPC H04L 27/262
USPC 375/267

(57) ABSTRACT

A Fast Fourier Transform (FFT) context-based reconfigurable instruction set processor (CRISP) machine receives N data symbols. The FFT CRISP includes multiply-accumulate (MAC) blocks, each configured to generate two intermediate results of a butterfly algorithm by calculating complex products and sums using the received data symbols and twiddle factors. The FFT CRISP includes a memory configured to store the received data symbols, the twiddle factors, and the intermediate results of the butterfly algorithm. The FFT CRISP includes a configurable instruction set digital signal processor core configured to: select and read a pair of the received data symbols from a location in the memory; input each selected pair of the received data symbols to the MAC blocks; write, to the location, the intermediate results the MAC blocks generated using the selected at least one pair of the N received data symbols; and output N binary symbols.

### CROSS-REFERENCE TO RELATED APPLICATIONS AND CLAIM OF PRIORITY

The present application claims priority to U.S. Provisional Patent Application Ser. No. 61/759,891, filed Feb. 1, 2013, entitled “EFFICIENT MULTIPLY-ACCUMULATE PROCESSOR FOR SOFTWARE DEFINED RADIO” and U.S. Provisional Patent Application Ser. No. 61/847,326 filed on Jul. 17, 2013, entitled “EFFICIENT MULTIPLY-ACCUMULATE PROCESSOR FOR SOFTWARE DEFINED RADIO.” The content of the above-identified patent documents are incorporated herein by reference.

### TECHNICAL FIELD

The present application relates generally to a wireless communication device and, more specifically, to performing a multiply-accumulate process using input data received by a an efficient multiply-accumulate processor for software defined radio.

### BACKGROUND

Wireless communications utilize digital filters for signal processing. In signal processing, implementing a digital filter with a general purpose (GP) central processing unit (CPU)/Digital Signal Processor (DSP) that have a power that is too high is a low efficiency solution for Finite Impulse Response (FIR)/Fast Fourier Transform (FFT). The WiXLE BB system is OFDM-based and requires the data symbols (post modulation) to be converted to Time-Domain by performing Inverse Discrete Fourier Transform (IDFT). The OFDM numerology of the WiXLE system consists of 29=512 sub-channels which mean that for every 512 symbols there are corresponding 512 sub-carriers. Since the number of data symbols is a power of 2, then a 512-point Inverse Fast Fourier Transform (IFFT) algorithm can be applied in the transmitter side instead of IDFT, and the corresponding 512-point FFT is used in the receiver side instead of DFT. The reason for using the FFT instead of DFT in this case is the reduced implementation complexity. While the FFT algorithm complexity is of O(NlogN) where N is the number of FFT points (i.e. 512), and the DFT complexity is of O(N2). However, in the case of WiXLE, where the expected data rate is in the order of 10s of Gbps which dictates extremely short OFDM symbol time, it requires the FFT implementation to be extremely high power efficient while still providing the highest BER performance. Further, there are several critical parameters, which are not independent of each other, that impact the FFT power efficiency.

### SUMMARY

A Multiply-Accumulate (MAC) processor machine is provided. The MAC processor machine includes an input interface configured to receive a number N of data symbols, the number N of data symbols being a power of 2. The MAC processor machine includes a number of multiply-accumulate (MAC) blocks. Each MAC block is configured to in response to receiving a pair of data symbols, execute a butterfly algorithm, generating a corresponding pair of intermediate results algorithm by calculating complex products and sums using the received pair of data symbols and twiddle factors. The MAC processor machine includes a memory configured to store the N received data symbols, the twiddle factors, and the intermediate results of the butterfly algorithm. The MAC processor machine includes a configurable instruction set digital signal processor core configured to: select and read at least one pair of the N received data symbols from a location in the memory; input each of the selected pair of the N received data symbols to the MAC blocks; write, to the location, the intermediate results the MAC blocks generated using the selected at least one pair of the N received data symbols; and output N binary symbols. Each binary symbol output from MAC processor machine corresponds to an order of the output and corresponds to a bit-reversal of a corresponding input from the selected pair of received data symbols.

A FFT CRISP for performing FFT and FIR filter processes is provided. The FFT CRISP machine includes an input interface configured to receive a number N of data symbols, the number N of data symbols being a power of 2. The FFT CRISP machine includes a number of multiply-accumulate (MAC) blocks. Each MAC block is configured to in response to receiving a pair of data symbols, execute a butterfly algorithm, generating a corresponding pair of intermediate results by calculating complex products and sums using the received pair of data symbols and twiddle factors. The FFT CRISP machine further includes a memory configured to store the N received data symbols, the twiddle factors, and the intermediate results of the butterfly algorithm. The FFT CRISP machine includes a configurable instruction set digital signal processor core configured to execute the FFT process by: selecting and read at least one pair of the N received data symbols to read from a location in the memory; inputting each of the selected pair of the N received data symbols to the MAC blocks; writing, to the location, the intermediate results the MAC blocks generated using the selected at least one pair of the N received data symbols; and outputting N binary symbols as a FFT of the received N data symbols, each binary symbol corresponding to an order of the output and corresponding to a bit-reversal of a corresponding input from the selected pair of received data symbols.

A method of computing a Fast Fourier Transform (FFT) of data symbols inputted to a FFT context-based reconfigurable instruction set processor (CRISP) machine is provided. The method includes receiving a number N of the data symbols into an input interface of the FFT CRISP machine, the number N being a power of 2. The method includes in response to receiving a pair of data symbols by a number of multiply-accumulate (MAC) blocks, executing a butterfly algorithm, generating a corresponding pair of intermediate results by calculating complex products and sums using the received pair of data symbols and twiddle factors. The method also includes storing the N received data symbols, the twiddle factors, and the intermediate results of the butterfly algorithm in a memory. The method includes selecting and reading, by a configurable instruction set digital signal processor core, at least one pair of the N received data symbols to read from a location in the memory. Also, the method includes inputting each of the selected pair of the N received data symbols to the MAC blocks. The method includes writing, to the location, the intermediate results the MAC blocks generated using the selected at least one pair of the N received data symbols. The method includes outputting N binary symbols, each binary symbol corresponding to an order of the output and corresponding to a bit-reversal of a corresponding input from the selected pair of received data symbols.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network that performs LDPC encoding and decoding according to the embodiments of the present disclosure;

FIGS. 2A and 2B illustrate an orthogonal frequency division multiple access (OFDMA) transmit path and receive path, respectively, according to embodiments of the present disclosure;

FIG. 3 illustrates a Fast Fourier Transform (FFT) CRISP Block Architecture according to an exemplary embodiment of this disclosure;

FIG. 4 illustrates a 16-point Decimation-In-Frequency (DIF) FFT Multiply-Accumulate algorithm 400 according to embodiments of the present disclosure.

FIG. 5 illustrates an 8-point Radix-2 FFT architecture 500 according to embodiments of the present disclosure;

FIG. 6 illustrates two single stage butterfly MAC algorithms equivalent to each other according to embodiments of the present disclosure;

FIG. 7 illustrates a memory arrangement of the data and the twiddle factors for the 8-point FFT 500 of FIG. 5;

FIG. 8 illustrates a complex data arrangement 800 in the memory blocks of the memory arrangement FIG. 7;

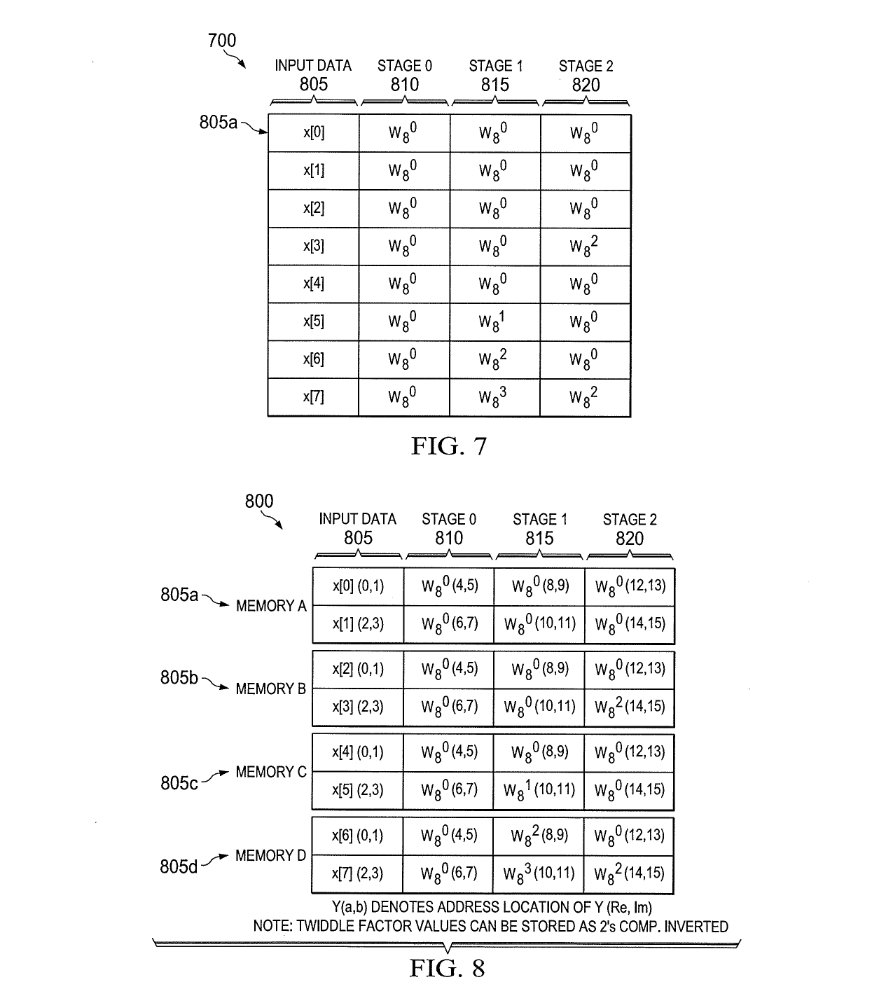

FIG. 7 illustrates an FFT CRISP Pipeline (2048-point Radix-2 DIF Example) according to embodiments of this disclosure;

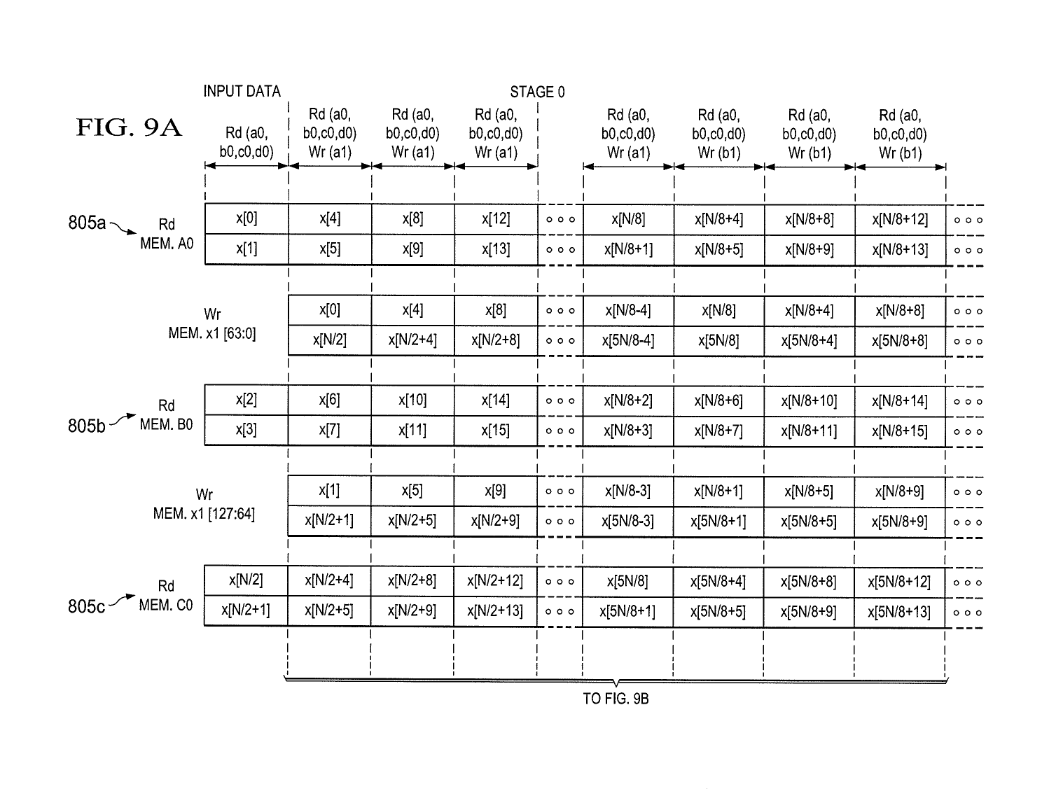

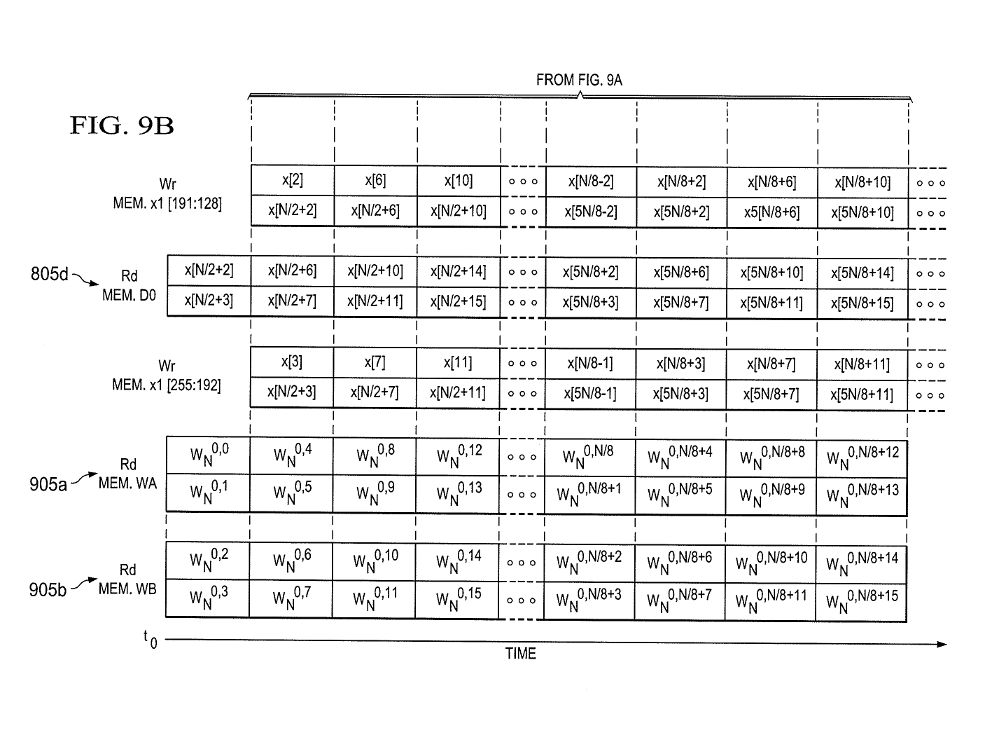

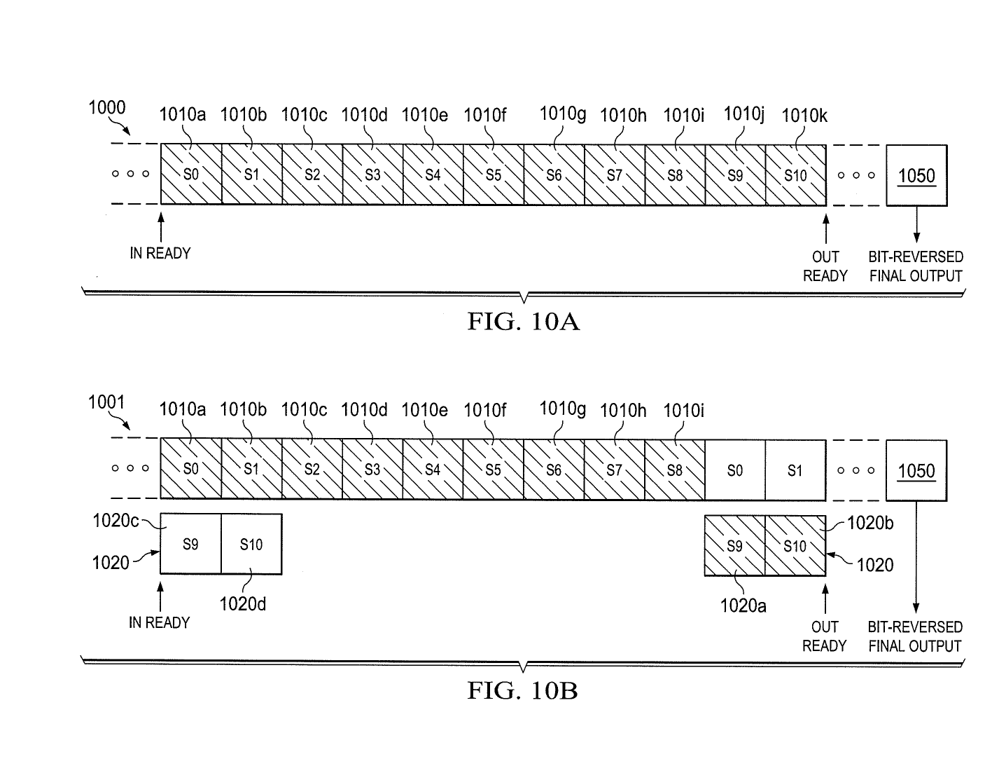

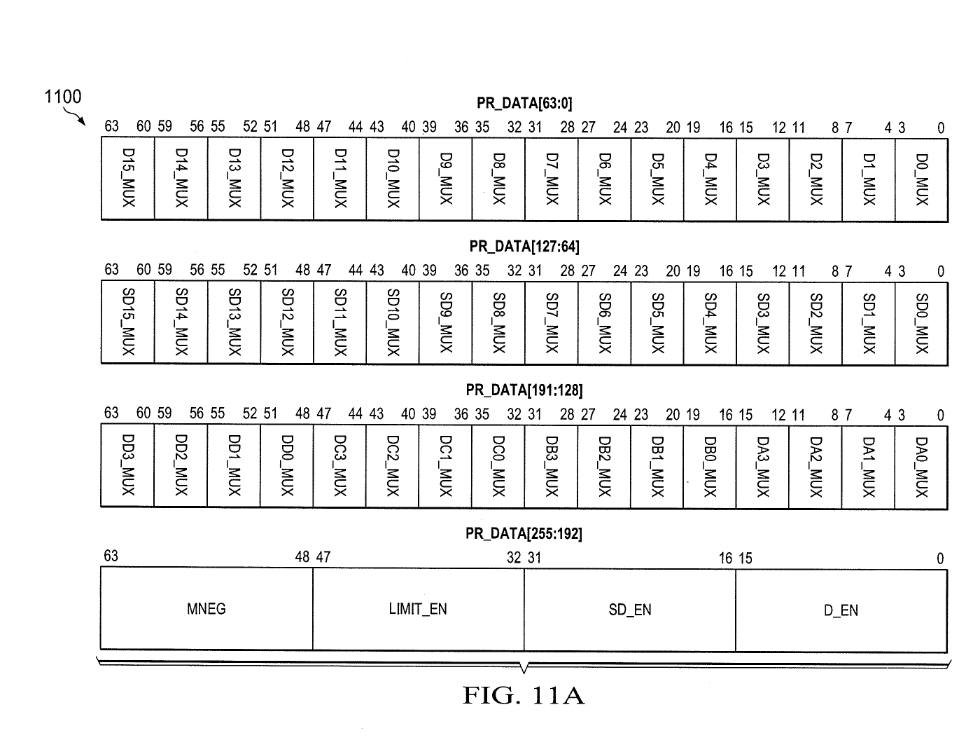

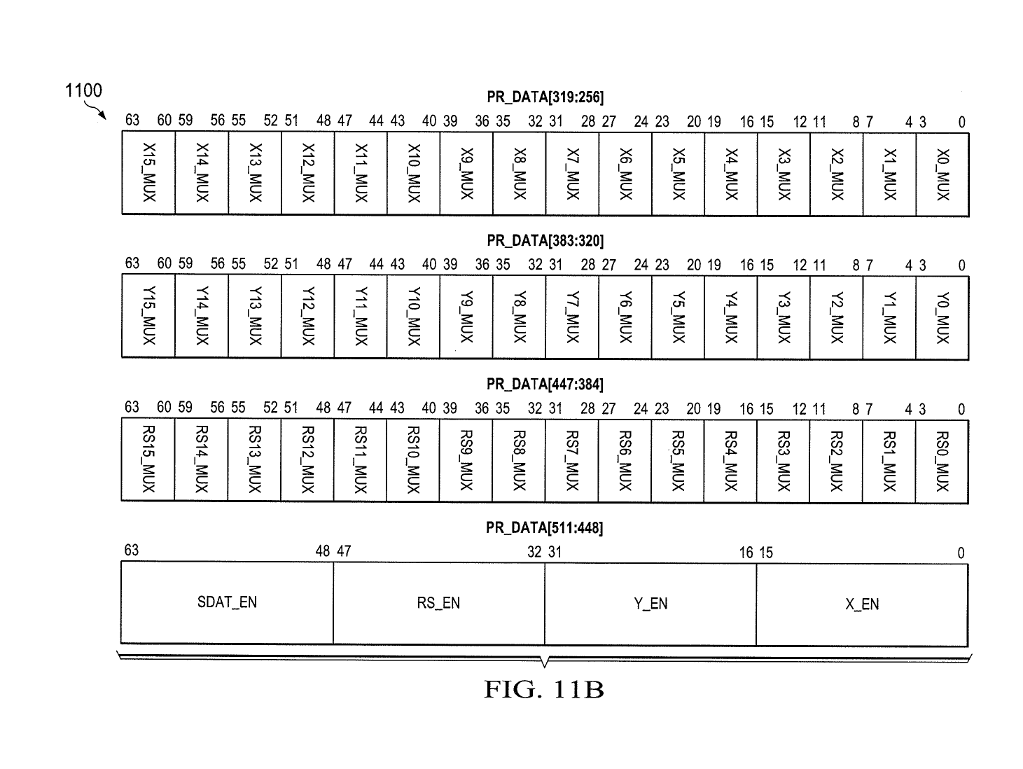

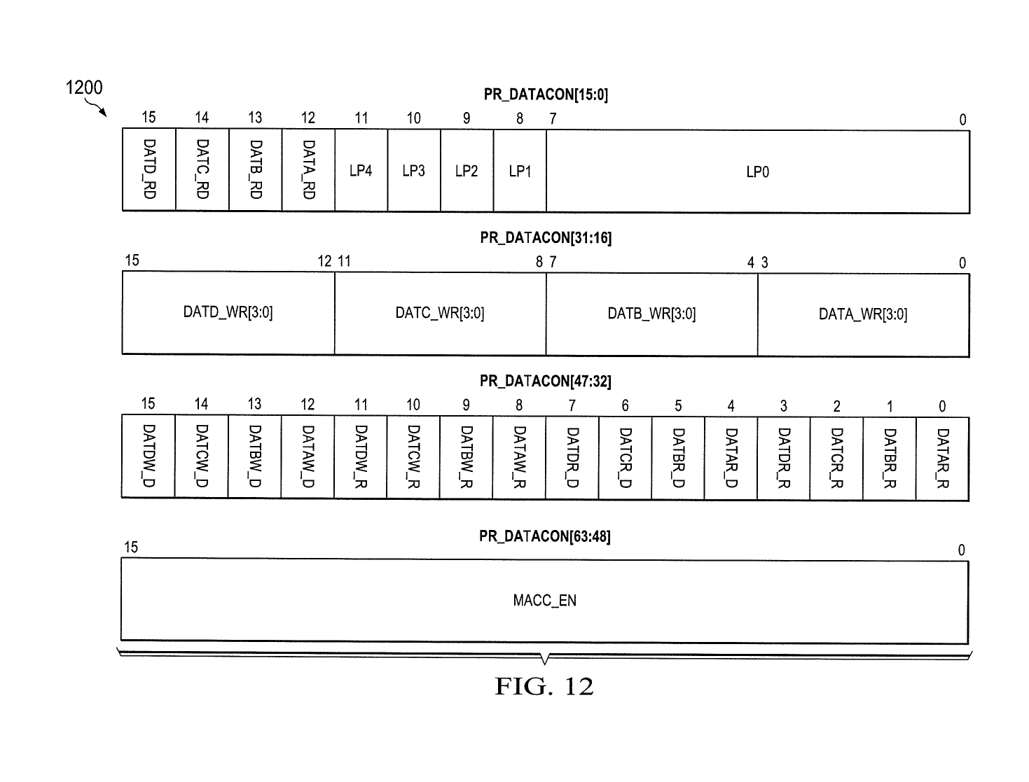

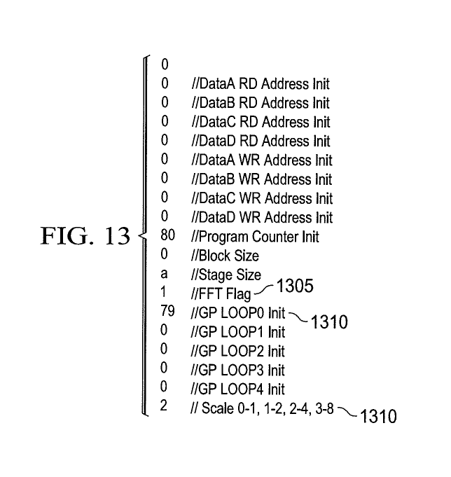

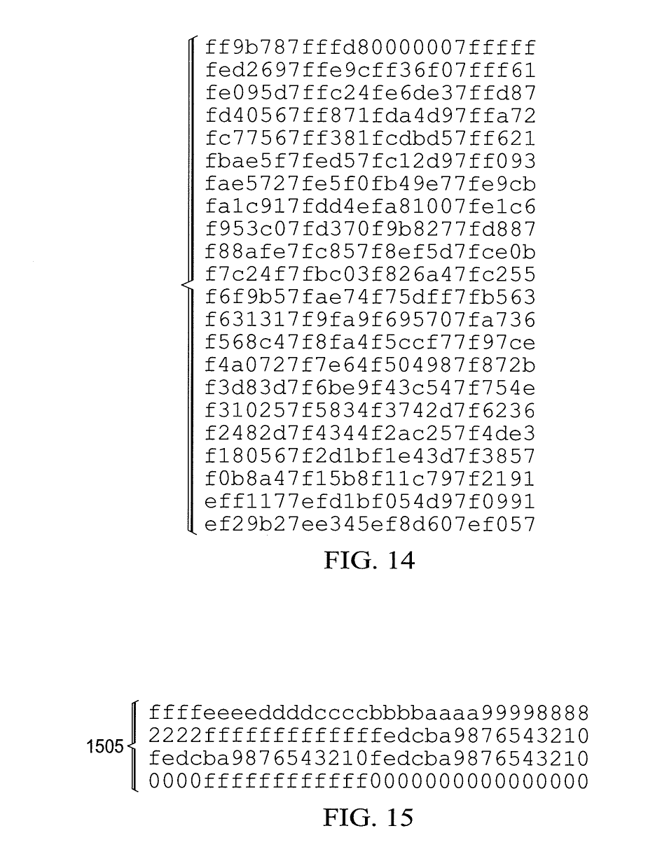

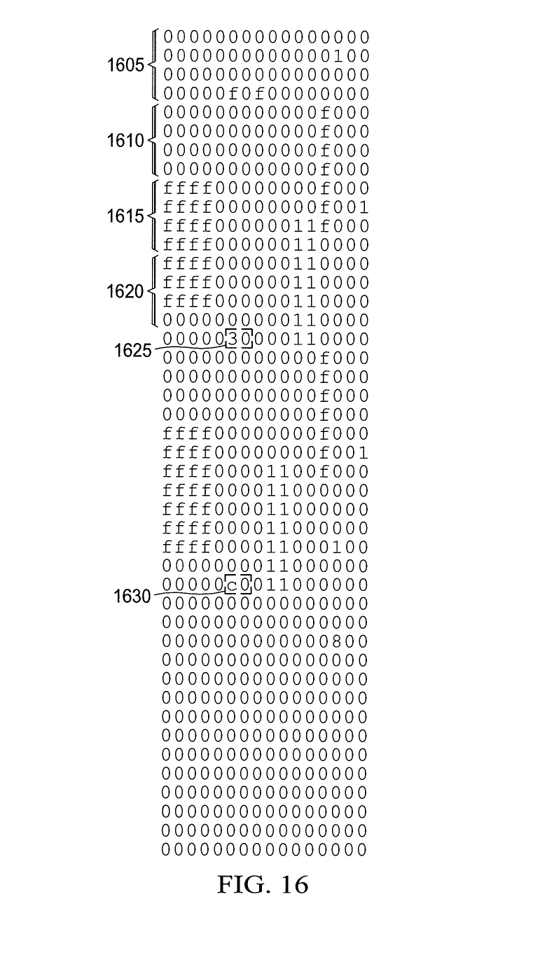

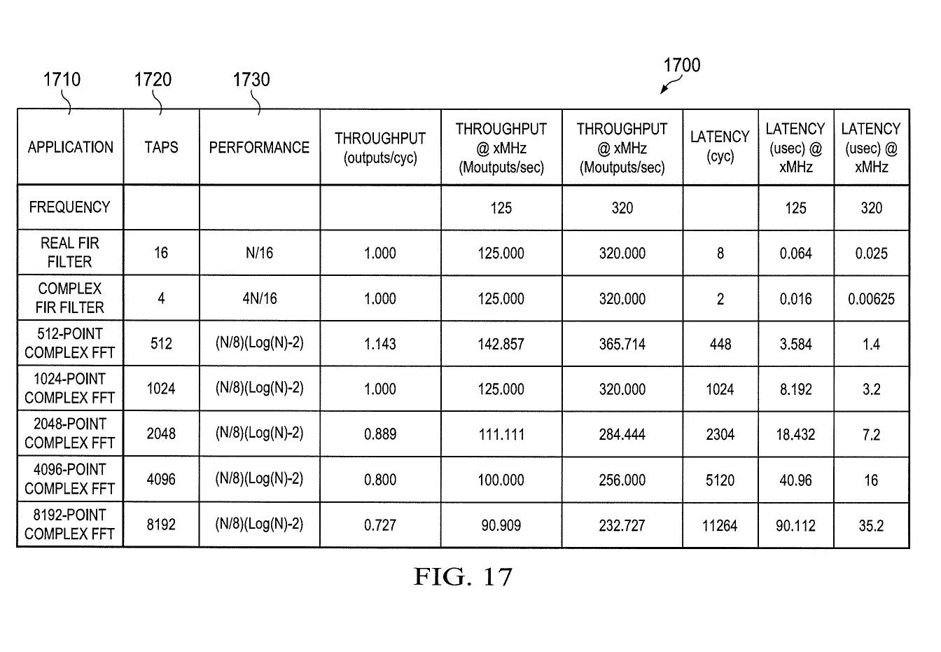

FIG. 8 illustrates an FFT CRISP Programming Model according to embodiments of this disclosure;

FIG. 9 illustrates a N-Point FFT Scheduling 800 for a fist, Stage 0 of and FFT CRISP according to embodiments of this disclosure.

FIGS. 10A and 10B illustrate an FFT CRISP Pipeline according to embodiments of this disclosure.

FIGS. 11-11B illustrate an FFT CRISP Programming Model 1100 according to embodiments of this disclosure;

FIG. 12 illustrates a Program Continuation Register according to embodiments of this disclosure;

FIG. 13 illustrates a 2048-point FFT Programming Example according to embodiments of this disclosure;

FIG. 14 illustrates a Twiddle Factor Memory Unit according to embodiments of this disclosure;

FIG. 15 illustrates a Program Fixed Instruction according to embodiments of this disclosure;

FIG. 16 illustrates a Program Loop Continuation according to embodiments of this disclosure; and

FIG. 17 illustrates FFT CRISP Latency and Throughput performances at different modes, points, and frequencies from tests of a Virtex-5 Field Programmable Gate Array (FPGA) according to embodiments of this disclosure.

### DETAILED DESCRIPTION

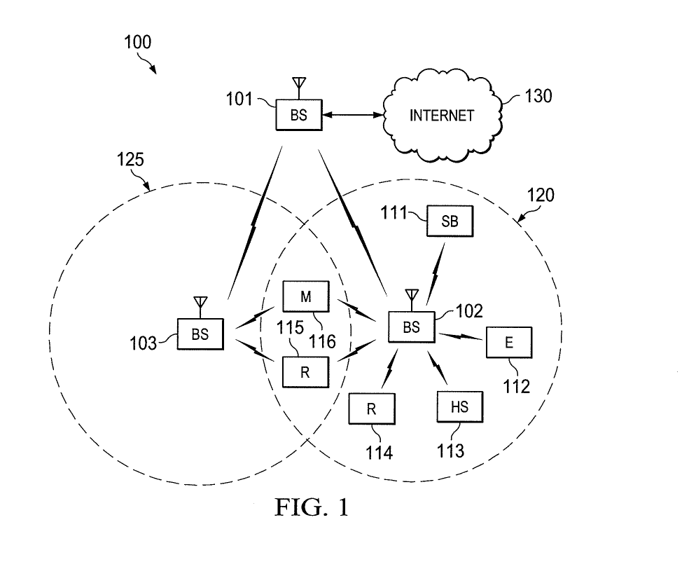

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device or system.

FIG. 1 illustrates a wireless network 100 that performs an LDPC encoding and decoding process according to the embodiments of the present disclosure, such as for an efficient multiply-accumulate processor for software based radio. The embodiment of the wireless network 100 shown in FIG. 1 is for illustration only. Other embodiments could be used without departing from the scope of this disclosure.

The wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of mobile stations within coverage area 120 of base station 102. The first plurality of mobile stations includes mobile station 111, which can be located in a small business (SB), mobile station 112, which can be located in an enterprise (E), mobile station 113, which can be located in a WiFi hotspot (HS), mobile station 114, which can be located in a first residence (R), mobile station 115, which can be located in a second residence (R), and mobile station 116, which can be a mobile device (M), such as a cell phone, a wireless laptop, a wireless PDA, or the like.

Base station 103 provides wireless broadband access (via base station 101) to Internet 130 to a second plurality of mobile stations within coverage area 125 of base station 103. The second plurality of mobile stations includes mobile station 115 and mobile station 116. In an exemplary embodiment, base stations 101-103 communicate with each other and with mobile stations 111-116 using orthogonal frequency division multiple (OFDM) or orthogonal frequency division multiple access (OFDMA) techniques.

Base station 101 can be in communication with either a greater number or a lesser number of base stations. Furthermore, while only six mobile stations are depicted in FIG. 1, it is understood that wireless network 100 can provide wireless broadband access to additional mobile stations. It is noted that mobile station 115 and mobile station 116 are located on the edges of both coverage area 120 and coverage area 125. Mobile station 115 and mobile station 116 each communicate with both base station 102 and base station 103 and can be said to be operating in handoff mode, as known to those of skill in the art.

Mobile stations 111-116 access voice, data, video, video conferencing, and/or other broadband services via Internet 130. In an exemplary embodiment, one or more of mobile stations 111-116 is associated with an access point (AP) of a WiFi WLAN. Mobile station 116 can be any of a number of mobile devices, including a wireless-enabled laptop computer, personal data assistant, notebook, handheld device, or other wireless-enabled device. Mobile stations 114 and 115 can be, for example, a wireless-enabled personal computer (PC), a laptop computer, a gateway, or another device.

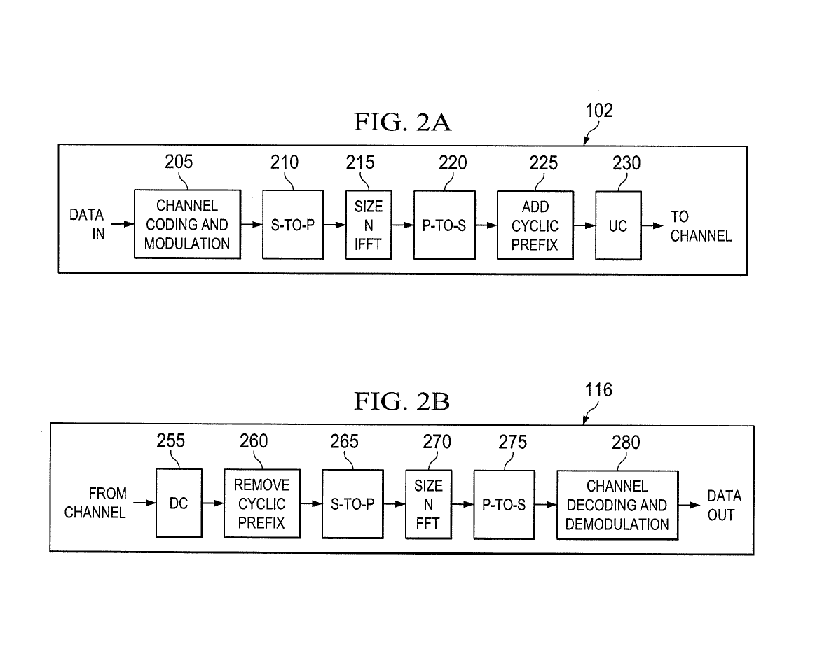

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in mobile station (MS) 116 for the purposes of illustration and explanation only. However, it will be understood by those skilled in the art that the OFDMA receive path also can be implemented in BS 102 and the OFDMA transmit path can be implemented in MS 116.

The transmit path in BS 102 includes channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in MS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B can be implemented in software while other components can be implemented by configurable hardware or a mixture of software and configurable hardware. In particular, it is noted that the FFT blocks and the IFFT blocks described in this disclosure document can be implemented as configurable software algorithms, where the value of Size N can be modified according to the implementation.

In BS 102, channel coding and modulation block 205 receives a set of information bits, applies LDPC coding and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and MS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal can also be filtered at baseband before conversion to RF frequency.

The transmitted RF signal arrives at MS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes (i.e., performs LDPC decoding) the modulated symbols to recover the original input data stream.

Each of base stations 101-103 implement a transmit path that is analogous to transmitting in the downlink to mobile stations 111-116 and implement a receive path that is analogous to receiving in the uplink from mobile stations 111-116. Similarly, each one of mobile stations 111-116 implement a transmit path corresponding to the architecture for transmitting in the uplink to base stations 101-103, such as for an efficient multiply-accumulate processor for software based radio, and implement a receive path corresponding to the architecture for receiving in the downlink from base stations 101-103, such as for an efficient multiply-accumulate processor for software based radio.

The channel decoding and demodulation block 280 decodes the received data. The channel decoding and demodulation block 280 includes a decoder configured to perform a low density parity check decoding operation. In some embodiments, the channel decoding and demodulation block 280 comprises one or more context-based operation reconfigurable instruction set processors (CRISPs), such as the CRISP processor(s) described in one or more of application Ser. No. 11/123,313, filed May 6, 2005 and entitled “Context-Based Operation Reconfigurable Instruction Set Processor And Method Of Operation”; U.S. Pat. No. 7,769,912, filed Jun. 1, 2005 and entitled “MultiStandard SDR Architecture Using Context-Based Operation Reconfigurable Instruction Set Processors”; U.S. Pat. No. 7,483,933, issued Jan. 27, 2009 and entitled “Correlation Architecture For Use In Software-Defined Radio Systems”; application Ser. No. 11/225,479, filed Sep. 13, 2005 and entitled “Turbo Code Decoder Architecture For Use In Software-Defined Radio Systems”; and application Ser. No. 11/501,577, filed Aug. 9, 2006 and entitled “Multi-Code Correlation Architecture For Use In Software-Defined Radio Systems”, all of which are hereby incorporated by reference into the present application as if fully set forth herein.

The WiXLE BB system is OFDM-based and requires the data symbols (post modulation) to be converted to time-domain by performing Inverse Discrete Fourier Transform (IDFT). The OFDM numerology of the WiXLE system includes 2⁹ sub-channels (namely, 5112 sub-channels) which means that for every 512 symbols there exists a corresponding 512 sub-carriers. The number of data symbols is a power of 2, and accordingly, a 512-point Inverse Fast Fourier Transform (IFFT) algorithm can be applied in the transmitter side instead of IDFT, and the corresponding 512-point FFT is used in the receiver side instead of DFT. The reason for using the FFT instead of DFT in this case is the reduced implementation complexity. While the FFT algorithm complexity is of O(NlogN) where N is the number of FFT points (that is, 512 points), and the DFT complexity is of O(N²). However, in the case of WiXLE, where the expected data rate is in the order of 10s of gigabits per second (Gbps), which dictates extremely short OFDM symbol time, the corresponding FFT implementation is extremely high power efficient while still providing the highest BER performance. Several parameters that impact the FFT power efficiency:

1. Input/Output data bit precision
2. Twiddle factor bit precision
3. Intermediate results bit precision

### 4. FFT Architecture (Radix, etc.)

These parameters are not independent to each other. For example, the intermediate results precision is dependent on the FFT Radix and the input data precision.

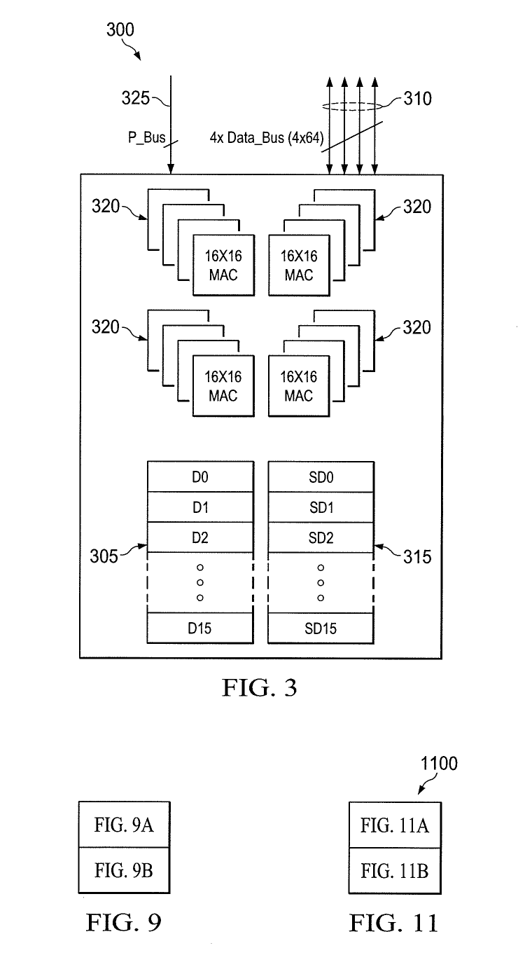

FIG. 3 illustrates a Fast Fourier Transform (FFT) CRISP IP Block Architecture according to an exemplary embodiment of this disclosure. The embodiment of the FFT CRISP 300 (also referred to as FFT IP) shown in FIG. 3 is for illustration only. Other embodiments could be used without departing from the scope of this disclosure.

The FFT IP 300 block is based on a configurable instruction set digital signal processor core called Context-based Reconfigurable Instruction Set Processor (CRISP™) architecture. A FFT CRISP™ IP block is described in reference to FIG. 3.

The FFT CRISP™ block 300 is based on Instruction Set architecture and can be used for any algorithm requiring multiplications such as but not limited to complex finite impulse response (FIR) or infinite impulse response (IIR) filters and FFT. The FFT CRISP™ block 300 includes 16× data registers 305 (D0-D15) that, in the case of FFT Mode, are used to store the input data. For example, the FFT CRISP™ block 300 includes input terminals coupled to a data bus 310. The data bus 310 includes four data buses, each configured to transmit 64 bits of data at the same time.

The FFT CRISP™ block 300 includes sixteen Y stored data registers 315 (SD0-SD15) that, in the case of FFT Mode store Twiddle Factor data.

The FFT CRISP™ block 300 includes sixteen Multiply-Accumulate (MAC) blocks 320 that are used to multiply and accumulate intermediate results. The FFT CRISP™ 300 can perform sixteen multiplications per cycle. Accordingly, in only two cycles the FFT CRISP™ 300 can perform eight complex multiplications. The MAC block 320 includes processing circuitry, which can be configured to execute any multiply-accumulate algorithm, such as an FFT process or a digital filter. The MAC block 320 includes a 16 input×16 output interface. Each of the sixteen inputs receives 16 bits at a time, and each of the sixteen outputs outputs 16 bits at a time. That is, a 16×16 MAC block 320 can receive or output 256 bits at once. In certain embodiments, the MAC block 320 is a 24×24 MAC or an 18×18 MAC.

An FIR filter is an example of a digital filter that the MAC block 320 can implement. The FIR filter includes data and coefficients that receive a stream of inputs, such as from a shift register. The data can be received as a single bit or multiple bits. Each input is multiplied by a corresponding coefficient. The output of the FIR filter includes a cumulative sum of the products of each data input multiplied its corresponding coefficient. For example, the output y can be represented by a convolutional equation: y(m)=Σᵢ₌₀^{k-1}xₘ₋₁Gᵢ, where m is the number of inputs, k is the number of coefficients, Gᵢ is the coefficient corresponding to the input xₘ₋₁.

The FFT CRISP™ block 300 includes a second input terminal 325 coupled to a P_Bus bus, which is a program bus for the instructions, for receiving twiddle factors. For example, the second input terminal 325 is can receive 16 bits of data at one time.

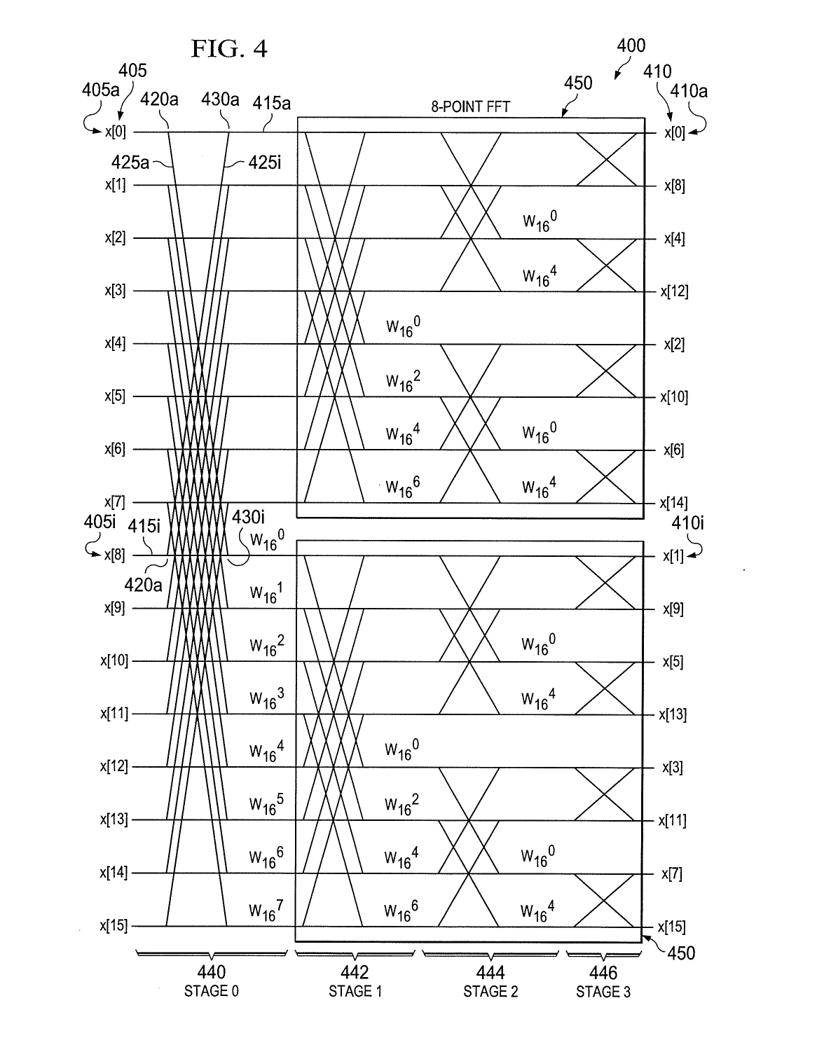

FIG. 4 illustrates a 16-point Decimation-In-Frequency (DIF) FFT Multiply-Accumulate algorithm 400 according to embodiments of the present disclosure. The DIF FFT MAC algorithm 400 is stored in a MAC processing block. For convenience, FIG. 4 can be described in terms of a specific non-limiting example including DIF Radix-2 Complex FFT for WiXLE for the FFT implementation in the FFT CRISP™ 300. The embodiment of the 16-point DIF FFT MAC algorithm 400 shown in FIG. 4 is for illustration only. Other embodiments could be used without departing from the scope of this disclosure.

The DIF FFT MAC algorithm 400 receives 256 bits of input x[0] through x[15] through an input interface of the MAC block 320, and then outputs 256 bits of outputs X[0] through X[15] through an output interface of the MAC block 320. That is, each input 405 corresponds to an output 410, shown by a horizontal line 415 from the input 405 to the output 410 (for example, from input x[0] 405a to output X[0] 410a). The DIF FFT MAC algorithm 400 includes multiple MAC butterfly algorithms.

One butterfly algorithm includes the two horizontal lines 415a and 415i corresponding to the first input/output combination of x[0] and X[0], and the ninth input/output combination of x[8] 405i and X[1] 410i; and the butterfly algorithm includes two criss-crossed diagonal lines 425a and 425i. From the perspective of the input x[0] 405a, the line 425a slopes rightward, towards the output, and the line 425i slopes leftward, away from the output. Similarly, from the perspective of the input x[8] 405i, the line 425i slopes rightward, towards the output, and the line 425a slopes leftward, away from the output. In the butterfly algorithm, operations flow from input to output, rightwardly. The horizontal line 415a includes a first intersection 420a with a rightward line 425a connected to the horizontal line 415i. Each intersection with a rightward sloping line represents a multiplication operation. Accordingly, at the first intersection 420a, the input data x[0] 405a is multiplied by the input data x[8] 405i. The horizontal line 415i includes a first intersection 420i with a rightward line 425i connected to the horizontal line 415a. Accordingly, at the first intersection 420i, the input data s[0] 405i is multiplied by the input data x[0] 405a. Next, in the butterfly algorithm, the horizontal line 415i includes a second intersection with the line 425i sloping leftward with respect to the input x[0]. Each intersection with a leftward sloping line represents an addition operation. Accordingly, at the second intersection 430a, the product of the input x[8] with input x[0] is accumulated with (that is, added to) the input x[0]. More particularly, the second intersection 430a can be represented by the expression (x[0])+(x[8]×x[0]). The second intersection 430i includes a twiddle factor (W_{N}^{k}), namely W₁₆⁰. A twiddle factor is a coefficient multiplied by the results of the operation performed at an intersection 420, 430. Twiddle Factors are defined in Equation 1:

$${W}_{N}^{k} = {e}^{\frac{- j2π k}{N}} \qquad [ Eqn . 1 ]$$

The second intersection 430i can be represented by the expression W₁₆⁰((x[8])+(x[0]×x[8])), where

$${W}_{N}^{k} = {e}^{\frac{- j2π 0}{16}} = 1.$$

The DIF FFT MAC algorithm 400 includes log(N) number of stages and N multiplications in each stage. The DIF FFT MAC algorithm 400 uses half as many MAC blocks per stage as number of multiplications in each stage

$${log}_{2} ( N ) \times \frac{N}{2}$$

MAC blocks per stage). The DIF FFT MAC algorithm 400 is based on powers of two. For example, in FIG. 4, N=16 for the DIF Radix-2 Complex FFT for WiXLE, and the DIF FFT MAC algorithm 400 includes log₂(N=16)=4 stages. The four stages include Stage 0 440, Stage 1 442, Stage 2 444, and Stage 3 446. Recursively, a 2×N Radix-2 FFT architecture relies on the N Radix-2 FFT architecture. Accordingly, the 16-point DIF Radix-2 Complex FFT architecture for WiXLE includes a basic 8-point Radix-2 FFT architecture 450. The basic 8-point Radix-2 FFT architecture 450 is used to derive higher point FFT implementations (for example, the 16 DIF Radix-2 Complex FFT for WiXLE 400). The number of points represents the number of input/outputs combinations.

Each input/output combination generates an output from the MAC block 320 that is a binary number corresponding to the output and in reverse order corresponding to the orinal of the input. Special attention is should be taken to re-order the FFT output offset locations that are in bit-reversed mode.

For example, the input/output combination of x[0] 405a and X[0] 410a generates the output 0000 corresponding to the X[0] output, and by reversing the bits of the output, the result is binary 0000 corresponding to the ordinal x[0] input. As another example, the input/output combination of x[1] and X[1] generates the output 1000 (namely, the number 8 in binary mode) corresponding to the ordinal X[1] output, and by reversing the bits of the output, the result is binary 0001 corresponding to the ordinal x[1] input. As a further example, the input/output combination of x[5] and X[10] generates the output 1010 (namely, the number 10 in binary mode) corresponding to the ordinal X[10] output, and by reversing the bits of the output, the result is binary 0101 corresponding to the ordinal x[5] input. Further examples of this correlation is described in Table 1 below:

TABLE 1
Input/Output Order corresponding to Output to Memory

| | | Binary Output | Bit-Reversed Output |
|---|---|---|---|
| Input | Output | (corresponds to | (corresponds to |
| Name | Name | Output Name) | Input Name) |
| x[0] | X[0] | 0000 | 0000 |
| x[1] | X[8] | 1000 | 0001 |
| x[2] | X[4] | 0100 | 0010 |
| x[3] | X[12] | 1100 | 0011 |
| x[4] | X[2] | 0010 | 0100 |
| x[5] | X[10] | 1010 | 0101 |
| x[6] | X[6] | 0110 | 0110 |
| x[7] | X[14] | 1110 | 0111 |
| x[8] | X[1] | 0001 | 1000 |
| x[9] | X[9] | 1001 | 1001 |
| x[10] | X[5] | 0101 | 1010 |
| x[11] | X[13] | 1101 | 1011 |
| x[12] | X[3] | 0011 | 1100 |
| x[13] | X[11] | 1011 | 1101 |
| x[14] | X[7] | 0111 | 1110 |
| x[15] | X[15] | 1111 | 1111 |

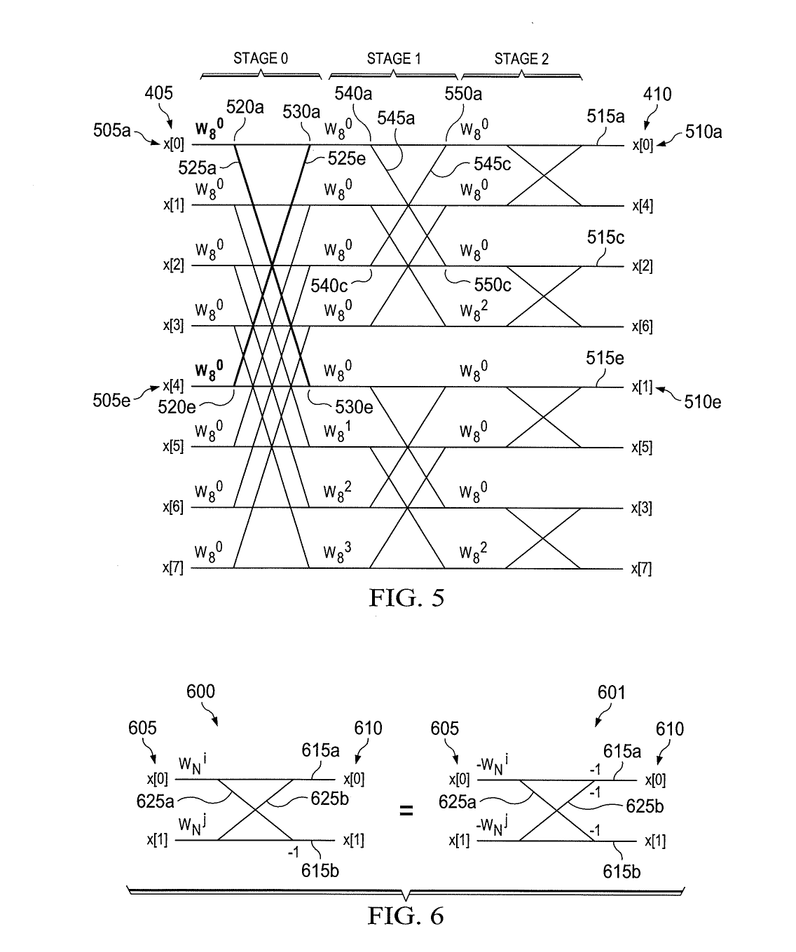

FIG. 5 illustrates an 8-point Radix-2 FFT architecture 500 according to embodiments of the present disclosure. For example, the basic 8-point Radix-2 FFT architecture 450 includes the 8-point Radix-2 FFT architecture 500. The embodiment of the 8-point Radix-2 FFT architecture 500 shown in FIG. 5 is for illustration only. Other embodiments could be used without departing from the scope of this disclosure. In certain embodiments, the 8-point Radix-2 FFT architecture 500 includes an 8-point FFT DIF algorithm, as shown in FIG. 5.

The 8-point Radix-2 FFT architecture 500 includes eight inputs (x[0]-x[7]), eight outputs X[0]-X[7], and three stages. The 8-point DIF FFT MAC algorithm 400 includes multiple (for example, such as four) MAC butterfly algorithms.

In the 8-point FFT DIF architecture 500, the butterfly algorithm of the first stage (Stage 0) spans half of the inputs (i.e., four input separation); the butterfly algorithm of the second stage (Stage 1) spans one-fourth of the inputs (i.e., two input separation); and the butterfly algorithm of the third stage (Stage 2) spans one-eighth of the inputs (i.e., consecutive inputs or one input separation).

One butterfly algorithm includes the two horizontal lines 515a and 515e corresponding to the first input/output combination of x[0] and X[0] and to the fifth input/output combination of x[4] 405i and X[1] 510e, respectively. The butterfly algorithm includes two crisscrossed diagonal lines 525a and 525e that each intersect both horizontal lines 515a and 515e. Each horizontal line includes at least one twiddle factor (W_{N}^{k}), as defined in Equation 1. Accordingly, at the first intersection 520a where line 525a intersects horizontal line 515a, the input data x[0] 505a is multiplied by the twiddle factor W₈⁰. The horizontal line 515e includes a first intersection 520e with a rightward line 525e that connects to the horizontal line 515a at the second intersection 530a.

At the first intersection 520e, the input data x[4] 505e is multiplied by the twiddle factor W₈⁰. The horizontal line 515a includes a second intersection 530a, where an accumulation operation occurs. At the second intersection 530a, the product at intersection 520a (namely, the twiddle factor multiplied by input x[0]) is accumulated with the product at the intersection 520e (namely, the twiddle factor and input x[4]). The accumulated sum at the second intersection 530a is multiplied by the twiddle factor W₈⁰ at the second intersection 530a. At the second intersection 530e, where line 525a intersects horizontal line 515e, the product at intersection 520e (namely, input data x[4] 505a multiplied by the twiddle factor W₈⁰) is accumulated with the product at intersection 520a. The accumulated sum at the second intersection 530e is multiplied by the twiddle factor W₈⁰ at the second intersection 530e. At the first intersection 520e, the input data s[0] 405i is multiplied by the input data x[0] 405a.

The intermediate results of Stage 0 are inputs to Stage 1. The intermediate results of Stage 0 include the results at the second intersections 530a and 530e. The results at the second intersection 530a can be expressed as ((x[0]×W₈⁰)+(x[4]×W₈⁰))×W₈⁰, and results at the second intersection 530e can be expressed as ((x[4]×W₈⁰)+(x[0]×W₈⁰))×W₈⁰.

Stage 1 includes four butterfly MAC algorithms. One of the Stage 1 butterfly algorithms includes two horizontal lines 515a and 515c, a diagonal line 545a connecting the two horizontal lines 515a and 515c at a third intersection 540a and fourth intersection 550c, and a diagonal line 545c connecting the two horizontal lines 515a and 515c at a third intersection 540c and fourth intersection 550a.

FIG. 6 illustrates two single stage butterfly MAC algorithms equivalent to each other according to embodiments of the present disclosure. A first 600 of the two single stage butterfly MAC algorithms includes one subtraction node. The second 601 of the two single stage butterfly MAC algorithms includes two subtraction nodes. The embodiments of the butterfly MAC algorithms 600-601 in FIG. 6 are for illustration purposes. Other embodiments could be used without departing from the scope of this disclosure.

The single stage butterfly MAC algorithm 600, 601 includes 2 points. That is, the 2 point MAC algorithm 600, 601 includes two horizontal lines 615a and 615b corresponding to the first input 605 and output 610 combination of x[0] and X[0] and to the second input/output combination of x[1] and X[1], respectively. The butterfly MAC algorithm 600 includes two crisscrossed diagonal lines 625a and 625b that each intersect both horizontal lines 615a and 615b.

In the first single stage butterfly MAC algorithm 600, a first multiplication operation generates a first product, wherein the input x[0] is multiplied by the twiddle factor Wk at the first intersection on the line 615a with the line 625a. At the same time, a second multiplication operation generates a second product, wherein the input x[1] is multiplied by the twiddle factor W_{N}^{j} at the first intersection on line 615b with the line 625b. Next, a first accumulate operation generates a first sum of the second product with the first product, which can be expressed as X[0]=(x[1]×W_{N}^{j})+(x[0]×W_{N}ⁱ). The first accumulate operation occurs at the second intersection on line 615a with the line 625b. At the same time, a second operation generates a second sum of the first product with the second product. The second accumulate operation occurs at the second intersection on line 615b with the line 625a, where −1 is the multiplier. The output of the second x[1] and X[1] input/output combination can be expressed as which can be expressed as X[1]=(x[0]×W_{N}ⁱ)−(x[1]×W_{N}^{j}).

In the first single stage butterfly MAC algorithm 601, a first multiplication operation generates a first product, wherein the input x[0] is multiplied by the twiddle factor −W_{N}ⁱ at the first intersection on the line 615a with the line 625a. At the same time, a second multiplication operation generates a second product, wherein the input x[1] is multiplied by the twiddle factor −W_{N}^{j} at the first intersection on line 615b with the line 625b. Next, a first accumulate operation generates a first sum of the second product with the first product. The first accumulate operation occurs at the second intersection on line 615a with the line 625b, where both lines 615a and 625b include a −1 multiplyer. The output 610 can be expressed as X[0]=((x[1]×−W_{N}^{j})+((x[0]×−W_{N}ⁱ)×−1). At the same time, a second operation generates a second sum of the first product with the second product. The second accumulate operation occurs at the second intersection on line 615b with the line 625a, where −1 is the multiplier. The output of the second x[1] and X[1] input/output combination can be expressed as which can be expressed as X[1]=((x[0]×−W_{N}ⁱ)×−1+(x[1]×−W_{N}^{j})).

The inputs x[0] and x[1] are the same for both single stage butterfly MAC algorithms 600 and 601. The outputs X[0] and X[1] are equivalent for both single stage butterfly MAC algorithms 600 and 601. The twiddle factors for each of the single stage butterfly MAC algorithms 600 and 601 include opposite signs.

FIG. 7 illustrates a memory arrangement of the data and the twiddle factors for the 8-point FFT 500 of FIG. 5. The memory arrangement 700 achieves 100% utilization of the FFT machine (also referred to as FFT CRISP). The embodiment of the memory arrangement 700 shown in FIG. 7 is for illustration only. Other embodiments could be used without departing from the scope of this disclosure.

Each of the data value stored in the memory consists of a complex number, including a real part and an imaginary part. That is, each input data 805 x[0]-x[7] includes a real part and imaginary part. Each twiddle factor stored in memory includes of a real part and imaginary part. A first column block of the memory arrangement 700 includes a 1×N array of input data 805. A second column block of the memory arrangement 700 includes a 1×N array of twiddle factors 810 for the first stage, Stage 0. A third column block of the memory arrangement 700 includes a 1×N array of twiddle factors 815 for the second stage, Stage 1. A fourth column block of the memory arrangement 700 includes a 1×N array of twiddle factors 820 for the second stage, Stage 2. In certain embodiments, the input data x[0] 505a is input to a corresponding block 805a of memory in the memory arrangement 700.

FIG. 8 illustrates a complex data arrangement 800 in the memory blocks of the memory arrangement FIG. 7. FIG. 8 shoes how the complex values are arranged in four different physical memory blocks. The embodiments of the complex data arrangement 800 in FIG. 8 are for illustration purposes. Other embodiments could be used without departing from the scope of this disclosure.

The complex data arrangement 800 includes a first memory block 805a (Memory A), a second memory block 805b (Memory B), a third memory block 805c (Memory C), and a fourth memory block 805d (Memory D). The four memory blocks 805a-d can be accessed in parallel by the FFT CRISP™ core. Each of the memory blocks 805a-805d port size support read/write of two complex data values (for example, a port size supporting read/write of four real data values). For example, in one instant, the FFT CRISP can read in the input data x[0](0,1) as the real part of x[0] into the 0 position and can read in the imaginary part into the 1 position of the Memory A block 805a. In the same instant, the FFT CRISP can read in the input data x[1] (2,3) as the real part of x[1] into the 2 position and can read in the imaginary part of x[1] into the 3 position of the Memory A block 805a.

FIG. 9 illustrates a N-Point FFT Scheduling 800 for a fist, Stage 0 of and FFT CRISP according to embodiments of this disclosure. FIG. 9 shows the stage 0 scheduling of the FFT processing for N-point FFT using the 16 MAC units processing four butterflies per cycle.

In the example shown, the FFT CRISP processes four butterfly MAC algorithms per cycle. At a time to, the FFT CRISP machine begins processing N number of input data points from the input data stored in memory blocks, for example, MemoryA0 805a, Memory B0 805b, Memory C0 805c, Memory D0 805d. That is, at time to, a first cycle begins, in which the FFT CRISP reads four values (a0, b0, c0, d0) from each memory block. For example, the value a0 can include the real part of the input x[0]; the value b0 can include the imaginary part of the input x[0]; the value c0 can include the real part of the input x[1]; the value d0 can include the imaginary part of the input x[1]. Also at time t0, the FFT CRISP machine reads in four values from the Memory block B0 805b for the inputs x[2] and x[3]; reads in four values from the Memory block C0 805c for the inputs

$$x [ \frac{N}{2} = 8 ] and x [ \frac{N}{2} + 1 = 9 ] ;$$

and reads in four values from the Memory block D0 805d for inputs

$$x [ \frac{N}{2} + 2 = 10 ] and x [ \frac{N}{2} + 3 = 11 ] .$$

Also at time t₀, to process the first cycle of a butterfly MAC, the FFT CRISP machine reads in twiddle factors from a memory block 905a-b separate from the input data memory locks 805a-d, including W_{N}^{0,0} and W_{N}^{0,1} from Memory block WA 905a, and including W_{N}^{0,2} and W_{N}^{0,3} from Memory block WB 905b. The twelve values read in during the first cycle enables the FFT CRISP to perform four butterflies MAC algorithms: a first butterfly of x[0], x[8], and W_{N}^{0,0}; a second butterfly of x[1], x[9], and W_{N}^{0,1}, a third butterfly of x[2], x[10], and W_{N}^{0,2}; and a fourth butterfly of x[3], x[11], and W_{N}^{0,3}.

During the second cycle, the intermediate results of the first four butterflies are written back the same memory address from which the input values were read in the previous cycle. For example, the intermediate results of the first butterfly (namely, using x[0], x[8], and W_{N}^{0,0}) are stored in MemoryA0 805a including bits 0-63. The intermediate results of the second butterfly (namely, using x[1], x[9], and W_{N}^{0,1}) are stored in MemoryB0 805b including bits 64-127. The intermediate results of the third butterfly (namely, using x[2], x[10], and W_{N}^{0,2}) are stored in MemoryC0 805c including bits 128-191. The intermediate results of the fourth butterfly (namely, using x[3], x[11], and W_{N}^{0,3}) are stored in Memory D0 805d including bits 192-255.

To complete a second set of four butterfly MAC algorithms, at a second time for the second cycle, the FFT CRISP machine reads in input data x[4] and x[5] into the Memory A0 block 805a; reads in input data x[6] and x[7] into the Memory B0 block 805b; reads in input

$$x [ \frac{N}{2} + 4 = 12 ] and x [ \frac{N}{2} + 5 = 13 ]$$

into Memory C0 block 805c; reads in input

$$x [ \frac{N}{2} + 6 = 14 ] and x [ \frac{N}{2} + 7 ] = 15 ]$$

into Memory D0 block 805d. The FFT CRISP machine reads in twiddle factors, including W_{N}^{0,4} and W_{N}^{0,5} from Memory block WA, and including W_{N}^{0,6} and W_{N}^{0,7} from Memory block WB.

During the second cycle, the FFT CRISP writes values to the memory block a1. For example, the inputs

$$x [ 0 ] and x [ \frac{N}{2} = 8 ]$$

are written to the memory block a1; the inputs

$$x [ \frac{N}{2} + 4 = 12 ] and x [ \frac{N}{2} + 5 = 13 ]$$

are written to the memory block a1; the inputs x[2] and

$$x [ \frac{N}{2} + 2 = 10 ]$$

are written to the memory block a1; and inputs

$$x [ \frac{N}{2} + 6 = 14 ] and x [ \frac{N}{2} + 7 = 15 ]$$

are written to the memory block a1. After the multiplication and accumulation of FIG. 4, one set of four butterflies are complete. The process continues until the end of Stage 0, whereafter, the outputs of Stage 0 are input to Stage 1.

In certain embodiments, the Scheduling 900 corresponds to the 16-point DIF Radix-2 FFT algorithm. That is, during the first cycle, x[0] 505a and x[8] are read from the Memory block a0. As a result, data bits cannot be written to a data address that is already in use. These inputs x[0] 505a and x[8] are multiplied by W_{N}⁰ according to the architecture in FIG. 5.

FIGS. 10A and 10B illustrate an FFT CRISP Pipeline according to embodiments of this disclosure. In the example shown, the FFT CRISP Pipeline 1000 includes a 2048-point Radix-2 DIF Pipeline with eleven stages 1010a-1010k (also referred to as S0-S10). Each stage can include a MAC processing block, such as MAC block 320. The FFT CRISP pipeline The FFT CRISP pipeline 1000 is for illustration only. Other embodiments could be used without departing from the scope of this disclosure.

In FIGS. 10A and 10B, the stages are processed sequentially—meaning a first set of data inputs x[0]-x[2047] to the first stage are processed at the first stage S0 1010a before the intermediate results from the first stage S0 1010a are processed by the second stage S1 1010b. In FIG. 10A, the process continues accordingly, wherein the intermediate results of the second stage 1010b are next processed by the third stage 1010c; the intermediate results of the ninth stage S8 1010i are next processed by the tenth stage 1010j; and finally, the intermediate results of the tenth stage 1010j are processed by the eleventh stage 1010k. After completion of the eleventh stage FFT processing of the first set of input data (x[0]-x[2047]) in the eleventh stage processing block 1010k, next, the eleventh stage processing block 1010k can process the eleventh stage FFT processing of a second set of input data (x[0]-x[2047]).

The FFT CRISP™ can process other higher Radixes (i.e., Radix-4). FIG. 10B shows that in certain embodiments, the FFT/IFFT processing in the FFT CRISP™ includes a specifically configured hardware accelerator 1020 to process the last two stages of the DIF pipelined to the rest of the stage processing. Processing in parallel the last two stages S9 and S10 of the first set of input data by the hardware accelerator processing blocks 1020a-1020b and processing (at the same time) the rest of the stages S0-S8 by the FFT CRISP pipeline 1010a-1010i increases the overall throughput of the FFT processing. Parallel processing during the last two stages increases throughput by about 20%. For example, the last two stages S9-S10 of a preceding set of input data can be processed by the hardware accelerator 1020c-d while the first two stages S0-S1 of the first set of input data are processed by the FFT CRISP blocks 1010a-1010b. The last two stages S9-S10 of the first set of input data is processed by the hardware accelerator blocks 1020a-b while the first two stages S0-S1 of the next set of input data is processed by the FFT CRISP blocks 1010a-b. The stages of the first data set are shown as shaded in FIGS. 10A-10B.

An advantage of using the last two stages in pipeline to begin processing a subsequent set of input data (also referred to as the rest of the processing) is that mathematically (as shown in Equations 2 and 3) the last two stages in the DIF FFT (S9, S10 in FIGS. 10A and 10B) do not require any multiplication. As a result, the MAC units 320 are not necessarily used. A dedicated hardware accelerator 1020 is added to process those last two stages in pipeline. Depending on the hardware frequency, the last two stages can be also processed in a single stage after or during processing of the ninth stage S8.

$$\begin{matrix}{W}_{N}^{\frac{N}{4}} = {e}^{\frac{- j2π N / 4}{N}} = {e}^{- \frac{jπ}{2}} = - j & [ Eqn . 2 ] \\ {W}_{N}^{\frac{N}{2}} = {e}^{\frac{- j2π N / 2}{N}} = {e}^{- jπ} = - 1 & [ Eqn . 3 ]\end{matrix}$$

As a result, the intermediate results of the ninth stage (also referred to in this example as the antepenultimate stage) S8 are input to the tenth stage 1010j, 1020a where multiplication by

$${W}_{N}^{\frac{N}{4}} = - j$$

occurs. The intermediate results from the tenth stage (also referred to in this example as the penultimate stage) S9 are then input to the eleventh, last stage S10 1010k, 1020b where multiplication by

$${W}_{N}^{\frac{N}{2}} = - 1$$

occurs.

In certain embodiments, the FFT CRISP includes a bit reverser 1050 configured receive the output from the last stage and to reorder the bits output from the last stage 1010k, 1020b (for example, S10). In operation, in response to receiving the output X[1]=1000 as shown in the second row of Table 1, the bit reverser 1050 performs bit reversal, outputing 0001.

FIGS. 11-11B illustrate an FFT CRISP Programming Model 1100 according to embodiments of this disclosure. Other programming models can be used without departing from the scope of this disclosure.

The program set is based on fully flexible VLIW Microcode instruction set.

1. The Program Register (Pr_data) is 512-bits long and performs routing of the data to-from the memory to the appropriate X/Y register. The Pr_data also performs routing of the Input/Output data to or from the accumulators. Table 2 includes a legend for reading the FFT CRISP Programming Model 1100.

TABLE 2
Legend for the FFT CRISP Programming Model

| Code | Description of function |
|---|---|
| (S)Dx_Mux | Selects the input to register (S)Dx either from the |
| | Accumulators (even Acc for x even and odd Acc for |
| | x odd) (0-7) or the Memory (even address for x |
| | even and odd address for x odd) (8-15). |
| DA/B/C/Dx_MUX | Selects the data to be written back to the |
| | corresponding memory (A/B/C/D) and Bank x. Data |
| | can be selects from D/SD registers. |
| (S)D_ENx | Enables the corresponding (S)Dx register (15:0). |
| LIMIT_ENx | Saturates the corresponding Dx register (15:0). |
| MNEGx | 2's Complement negate the corresponding |
| | Multiplier x when accumulated in MAC unit x |
| | (15:0). |
| Xa_MUX | Selects the first input to Multiplier ‘a’ from D |
| | registers (0-15). |
| Ya_MUX | Selects the second input to Multiplier ‘a’ from SD |
| | registers (0-15). |
| RSa_MUX | Selects the init value for Accumulator ‘a’ from D |
| | registers (0-15). |
| X_EN | Enables the first input to the corresponding |
| | multiplier (15:0). |
| Y_EN | Enables the second input to the corresponding |
| | multiplier (15:0). |
| RS_EN | Enables the init value to the corresponding |
| | Accumulator (15:0). |
| SDAT_EN | Selects either SD or D to be written back to |
| | memory A/B/C/D 0-3 (15:0). |

FIG. 12 illustrates a Program Continuation Register according to embodiments of this disclosure. The Program Continuation Register (Pr_datacon) programming model 1200 is 64-bits wide. The Pr_datacon programming model 1200 is can control all the memory access switching and address control. Pr_datacon programming model 1200 controls the looping mechanism and the accumulator control. Table 3 includes a legend for reading the Pr_datacon programming model 1200.

TABLE 2
Legend for the Program Continuation Register programming model

| Code | Description |
|---|---|
| LP0 | Single instruction loop value denotes the number |
| | of iterations. |
| LPx | Multi-instruction loop 1-4 hierarchies. |
| DATAx_Rd | Read instruction from memory x |
| DATAx_WRy | Write instruction to memory x bank y. |
| DATxR_R | Resets the Read address of Memory x to initial |
| | value. |
| DATxR_D | Decrement(1)/Increment(0) the Read address of |
| | Memory x. |
| DATxW_R | Resets the Write address of Memory x to initial |
| | value. |
| DATxW_D | Decrement(1)/Increment(0) the Write address of |
| | Memory x. |
| MACC_EN | Enable the corresponding MAC unit (15:0) |

FIG. 13 illustrates a 2048-point FFT Programming Example according to embodiments of this disclosure. The embodiment of the 2048-point FFT Programming Example shown in FIG. 13 is for illustration only. Other embodiments could be used without departing from the scope of this disclosure.

In the FFT Programming Example, the programming code for the FFT Flag 1305 represents parallelism enabled when the bit is a 1 (as shown) and represents parallelism disabled when the bit is a 0. When parallelism is enabled, the last two stages of the FFT CRISP pipeline use the hardware accelerator 1020 and the pipeline schedule 1001, but when parallelism is disabled, the last two stages of the FFT CRISP pipeline use the pipeline schedule 1000.

In the FFT Programming Example, the programming code for the GP LOOP0 Init 1310 indicates a whether to loop the corresponding portion of the code again.

In the FFT Programming Example, the programming code for the Scale 1315 indicates how much to scale the intermediate results of a processing stage by before truncating the intermediate results. Truncating prevents 32-bit saturation of a 16×16 MAC block. Scaling prevents truncating important data during the truncation process that follows scaling. For example, a code of 0 indicates to not scale; a code of 1 indicates to divide by (also referred to as scale by) order of 2; a code of 2 (as shown) indicates to divide by order of 4; and a code of 3 indicates to divide by order of 8. For example, during an FFT processing, the input x[0] is multiplied by the input x[8] in a butterfly MAC algorithm. The product of the inputs x[0] and x[8] are multiplied by a twiddle factor W₁₆⁰. The product of the twiddle factor W₁₆⁰ and two inputs x[0] and x[8] is input to the second accumulator (adder), and then the accumulation result is scaled by a specified scale factor. Then, the scaled product is a 32-bit data that is truncated by 16-bits, resulting in a 16-bit scaled-truncated result that is input to the next stage MAC.

FIG. 14 illustrates a Twiddle Factor Memory Unit according to embodiments of this disclosure. The embodiment of the Twiddle Factor Memory Unit shown in FIG. 14 is for illustration only. Other embodiments could be used without departing from the scope of this disclosure.

FIG. 15 illustrates a Program Fixed Instruction according to embodiments of this disclosure. The embodiment of the Program Fixed Instruction shown in FIG. 15 is for illustration only. Other embodiments could be used without departing from the scope of this disclosure. The four lines of the Program Fixed Instruction 1510 represent processing for 2048 bit points.

FIG. 16 illustrates a Program Loop Continuation according to embodiments of this disclosure. The embodiment of the Program Loop Continuation shown in FIG. 16 is for illustration only. Other embodiments could be used without departing from the scope of this disclosure. In the Program Loop Continuation, each line represents a cycle.

In the Program Loop Continuation, the first four lines 1605 represent processing represent of four stages (for example, S0-S3); the second four lines 1610 represent processing of four stages (for example, S4-S7); the third four lines 1615 represent processing of four stages (for example, S8-S11); and the fourth four lines 1620 represent processing of four stages (for example, S12-S15). That is, each set of four lines 1605, 1610, 1615, 1620 can include a program fixed instruction, similar to the Program Fixed Instruction 1510. In hex mode, the code 1625 and 1630, each represents a loop indicator.

FIG. 17 illustrates a table 1700 of FFT CRISP Latency and Throughput performances at different modes, points, and frequencies from tests of a Virtex-5 Field Programmable Gate Array (FPGA) according to embodiments of this disclosure. The FFT CRISP performs multiple MAC operations per cycle hence it can easily support Real and Complex FIR filtering.

In the table, the Taps 1720 column includes the number of taps, also referred to as the number of points N. In the table, the Performance 1730 column includes the number of cycles to complete the process described in the Application 1710 column. In the Application of a Real FIR filter, the number of taps is N=16. The MAC processor machine (which can include the Virtex-5 FPGA) includes one MAC block for each tap. In the FIR filter process, each MAC block includes one tap, which receives real numbers as inputs. That is, the tap of each MAC receives a real number of input data and a real number coefficient. The MAC processor machine executes an FIR filter process by multiplying each input data by a coefficient corresponding to that input data within the MAC block that received the input data and corresponding coefficient, and by next accumulating the N products in an adder. The MAC processor machine outputs the results from the adder after

$$\frac{N}{16}$$

cycles (in the example shown,

$$\frac{N = 16}{16} = 1 cycle \text{)} .$$

In the example shown, a 16-tap Real FIR Filter MAC processor machine can perform 16 multiplications per 1 cycle.

In the Application of a Complex FIR filter, the number of complex taps is N=4. The MAC processor machine (which can include the Virtex-5 FPGA) includes one complex MAC block for each complex tap. In the FIR filter process, each MAC block includes one tap, which receives complex numbers as inputs. That is, the tap of each complex MAC receives one complex input data and a complex coefficient; the complex input data includes a real number portion and imaginary number portion. The corresponding complex coefficient includes a real number portion and imaginary number portion. The MAC processor machine executes an FIR filter process by multiplying each input data by a coefficient corresponding to that input data within the complex MAC block that received the input data and corresponding coefficient, and by next accumulating the N products in an adder. The complex MAC block includes four butterfly algorithm MAC blocks. A first of the four butterfly algorithm MAC blocks multiplies the real number portion of the input data by the real number portion of the coefficient. A second of the four butterfly algorithm MAC blocks multiplies the real number portion of the input data by the imaginary number portion of the coefficient. A third of the four butterfly algorithm MAC blocks multiplies the imaginary number portion of the input data by the real number portion of the coefficient. A fourth of the four butterfly algorithm MAC blocks multiplies the imaginary number portion of the input data by the imaginary number portion of the coefficient.

The MAC processor machine outputs the results from the adder after

$$\frac{4 N}{16}$$

cycles (in the example shown,

$$\frac{4 N = 16}{16} = 1 cycle \text{)} .$$

In the example shown, a 4-tap Complex FIR Filter MAC processor machine can perform 4 complex multiplications per 1 cycle. Accordingly, the 4-tap Complex FIR Filter MAC processor machine can perform 16 complex multiplications in 4 cycles.

In the Complex FFT Applications, the performance 1030 is related to the number of tapes by the expression: (N/8)×(Log(N)−2). Accordingly, the 512-Point Complex FFT application has N=512 complex taps and performs complex multiplications in (N/8)×(Log₂(N)−2)=64×(9−2)=448 cyles.

Although the present disclosure has been described with examples, various changes and modifications may be suggested to one skilled in the art. It is intended that the present disclosure encompass such changes and modifications as fall within the scope of the appended claims.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A Multiply-Accumulate (MAC) processor machine comprising:
an input interface configured to receive a number N of data symbols, the number N of data symbols being a power of 2;
a number of multiply-accumulate (MAC) blocks, each MAC block configured to, in response to receiving a pair of data symbols, execute a butterfly algorithm to generate a corresponding pair of intermediate results by calculating complex products and sums using the received pair of data symbols and twiddle factors;
a memory configured to store the N received data symbols, the twiddle factors, and the intermediate results of the butterfly algorithm; and
a configurable instruction set digital signal processor core configured to:
select and read at least one pair of the N received data symbols to read from a location in the memory,
input each of the selected pair of the N received data symbols to the MAC blocks,
write, to the location, the intermediate results the MAC blocks generated using the selected at least one pair of the N received data symbols, and
output N binary symbols, each binary symbol corresponding to an order of the output and corresponding to a bit-reversal of a corresponding input from the selected pair of received data symbols.

2. The MAC processor machine as set forth in claim 1, wherein a subset of the MAC blocks are arranged in a sequence of processing stages, the sequence of stages comprising log(N) stages and N multiplications in each stage, and each subset of the MAC blocks comprising
$${log}_{2} ( N ) \times \frac{N}{2}$$
MAC blocks per stage.

3. The MAC processor machine as set forth in claim 2, wherein the configurable instruction set digital signal processor core is further configured to:
input the N received data symbols to the subset of the MAC blocks of a first stage of the sequence of stages;
in response to generating N intermediate results from the first stage, inputting the N intermediate results from the first stage to the subset of MAC blocks of a second stage of the sequence of stages.

4. The MAC processor machine as set forth in claim 3, wherein the configurable instruction set digital signal processor core is further configured to determine that the first stage is an antepenultimate stage of the sequence of stages; and
wherein the MAC processor further comprises a hardware accelerator configured to receive intermediate results of the antepenultimate stage, perform a last two stages of the sequence of stages in parallel with performing a first two stages of the sequence of stages using a subsequent set of input data symbols,
wherein a penultimate stage of the sequence of stages is configured to output a complex complement of the intermediate results of the antepenultimate stage, and
wherein a last stage of the sequence of stages is configured to output a negative of the intermediate results of the penultimate stage.

5. The MAC processor machine as set forth in claim 4, wherein the output of the last stage is coupled to an output reorderer configured to perform a bit reversal of the results of the last stage.

6. The MAC processor machine as set forth in claim 1, wherein the configurable instruction set digital signal processor core comprises a very long instruction word (VLIW) configured to control switches independently to input each of the selected pair of the N received data symbols to the MAC blocks.

7. The MAC processor machine as set forth in claim 1, wherein the configurable instruction set digital signal processor core comprises a single instruction multiple data (SIMD) configured to control switches that are partly dependent upon a status of each other to input each selected pair of the N received data symbols to the MAC blocks.

8. The MAC processor as set forth in claim 1, wherein the memory comprises an array or rows and columns, the array comprising:
one column configured to store the N data symbols in ascending order;
a number of stage columns corresponding to a sequence of processing stages, each stage columns configured to store a set of twiddle factors for the corresponding processing stage; and
a number of memory blocks, each memory block comprising two consecutive rows of the array, wherein the number of memory blocks is
$$\frac{N}{2} .$$

9. The MAC processor as set for in claim 1, wherein the configurable instruction set digital signal processor core is further configured to execute at least one of:
a Fast Fourier Transform (FFT) process,
a Finite Impulse Response (FIR) filter process,
an Infinite Impulse Response (IIR) filter process, and
a digital filter process.

10. A Fast Fourier Transform (FFT) context-based reconfigurable instruction set processor (CRISP) machine for performing a FFT process, the FFT CRISP machine comprising:
an input interface configured to receive a number N of data symbols, the number N of data symbols being a power of 2;
a number of multiply-accumulate (MAC) blocks, each MAC block configured, to in response to receiving a pair of data symbols, execute a butterfly algorithm to generate a corresponding pair of intermediate results by calculating complex products and sums using the received pair of data symbols and twiddle factors; and
a memory configured to store the N received data symbols, the twiddle factors, and the intermediate results of the butterfly algorithm; and
a configurable instruction set digital signal processor core configured to execute the FFT process by:
selecting and read at least one pair of the N received data symbols to read from a location in the memory,
inputting each of the selected pair of the N received data symbols to the MAC blocks,
writing, to the location, the intermediate results the MAC blocks generated using the selected at least one pair of the N received data symbols, and
outputting N binary symbols as a FFT of the received N data symbols, each binary symbol corresponding to an order of the output and corresponding to a bit-reversal of a corresponding input from the selected pair of received data symbols.

11. The FFT CRISP machine as set forth in claim 10, wherein a subset of the MAC blocks are arranged in a sequence of FFT computation stages, the sequence of FFT computation stages comprising log(N) stages and N multiplications in each stage, and each subset of the MAC blocks comprising
$${log}_{2} ( N ) \times \frac{N}{2}$$
MAC blocks per stage.

12. The FFT CRISP machine as set forth in claim 11 wherein the configurable instruction set digital signal processor core is further configured to:
input the N received data symbols to the subset of the MAC blocks of a first stage of the sequence of FFT computation stages;
in response to generating N intermediate results from the first stage, inputting the N intermediate results from the first stage to the subset of MAC blocks of a second stage of the sequence of stages.

13. The FFT CRISP machine as set forth in claim 12, wherein the configurable instruction set digital signal processor core is further configured to determine that the first stage is an antepenultimate stage of the sequence of FFT computation stages; and
wherein the FFT CRISP further comprises a hardware accelerator configured to receive intermediate results of the antepenultimate stage, perform a last two stages of the sequence of FFT computation stages in parallel with performing a first two stages of the sequence of stages using a subsequent set of input data symbols,
wherein a penultimate stage of the sequence of stages is configured to output a complex complement of the intermediate results of the antepenultimate stage, and
wherein a last stage of the sequence of stages is configured to output a negative of the intermediate results of the penultimate stage.

14. The FFT CRISP machine as set forth in claim 13, wherein the output of the last stage is coupled to an output reorderer configured to perform a bit reversal of the results of the last stage.

15. The FFT CRISP machine as set forth in claim 10, wherein the configurable instruction set digital signal processor core comprises a very long instruction word (VLIW) configured to control switches independently to input each of the selected pair of the N received data symbols to the MAC blocks.

16. The FFT CRISP machine as set forth in claim 10, wherein the configurable instruction set digital signal processor core comprises a single instruction multiple data (SIMD) configured to control switches that are partly dependent upon a status of each other to input each selected pair of the N received data symbols to the MAC blocks.

17. The FFT CRISP as set forth in claim 10, wherein the memory comprises an array or rows and columns, the array comprising:
one column configured to store the N data symbols in ascending order;
a number of stage columns corresponding to a sequence of processing stages, each stage columns configured to store a set of twiddle factors for the corresponding processing stage; and
a number of memory blocks, each memory block comprising two consecutive rows of the array, wherein the number of memory blocks is
$$\frac{N}{2} .$$

18. A method of computing a Fast Fourier Transform (FFT) of data symbols inputted to a FFT context-based reconfigurable instruction set processor (CRISP) machine, the method comprising:
receiving a number N of the data symbols into an input interface of the FFT CRISP machine, the number N being a power of 2;
in response to receiving a pair of data symbols by a number of multiply-accumulate (MAC) blocks, executing a butterfly algorithm to generate a corresponding pair of intermediate results by calculating complex products and sums using the received pair of data symbols and twiddle factors; and
storing the N received data symbols, the twiddle factors, and the intermediate results of the butterfly algorithm in a memory;
selecting and reading, by a configurable instruction set digital signal processor core, at least one pair of the N received data symbols to read from a location in the memory,
inputting each of the selected pair of the N received data symbols to the MAC blocks,
writing, to the location, the intermediate results the MAC blocks generated using the selected at least one pair of the N received data symbols, and
outputting N binary symbols, each binary symbol corresponding to an order of the output and corresponding to a bit-reversal of a corresponding input from the selected pair of received data symbols.

19. The method as set forth in claim 18, wherein a subset of the MAC blocks are arranged in a sequence of processing stages, the sequence of stages comprising log(N) stages and N multiplications in each stage, and each subset of the MAC blocks comprising
$${log}_{2} ( N ) \times \frac{N}{2}$$
MAC blocks per stage.

20. The method as set forth in claim 19, further comprising:
inputting the N received data symbols to the subset of the MAC blocks of a first stage of the sequence of stages;
in response to generating N intermediate results from the first stage, inputting the N intermediate results from the first stage to the subset of MAC blocks of a second stage of the sequence of stages.

21. The method as set forth in claim 20, further comprising:
in response to determining that the first stage is an antepenultimate stage of the sequence of stages, receiving intermediate results of the antepenultimate stage by a hardware accelerator of the FFT CRISP;
performing, by the hardware accelerator, a last two stages of the sequence of stages in parallel with performing a first two stages of the sequence of stages using a subsequent set of input data symbols,
wherein a penultimate stage of the sequence of stages is configured to output a complex complement of the intermediate results of the antepenultimate stage, and
wherein a last stage of the sequence of stages is configured to output a negative of the intermediate results of the penultimate stage.

22. The method as set forth in claim 20, further comprising
performing, by an output reorderer coupled to receive the output of the last stage, a bit reversal of the results of the last stage.

23. The method as set forth in claim 18, further comprising providing a memory comprising an array or rows and columns, the array comprising:
one column configured to store the N data symbols in ascending order;
a number of stage columns corresponding to a sequence of processing stages, each stage columns configured to store a set of twiddle factors for the corresponding processing stage; and
a number of memory blocks, each memory block comprising two consecutive rows of the array, wherein the number of memory blocks is
$$\frac{N}{2} .$$
